(19) United States
(12) Patent Application Publication
(10) Pub. No.: US 2022/0277359 A1
(43) Pub. Date: Sep. 1, 2022

(54) A SYSTEM AND A METHOD FOR ENABLING INTERACTION BETWEEN AVAILERS AND PROVIDERS

(71) Applicant: CACTUS COMMUNICATIONS PVT LTD, Mumbai (IN)

(72) Inventors: Anurag GOEL, Mumbai (IN); Abhishek GOEL, Mumbai (IN); Satyajit ROUT, Mumbai (IN)

(21) Appl. No.: 17/628,769

(22) PCT Filed: Jul. 17, 2020
(86) PCT No.: PCT/IB2020/056726

§ 371 Date: Jan. 20, 2022

(30) Foreign Application Priority Data
Jul. 24, 2019 (IN) 201921029960

(51) Int. Cl. G06Q 30/02; G06F 16/35

(52) U.S. Cl. CPC G06Q 30/0279; G06F 16/35

(57) ABSTRACT

The present invention provides a system and method for enabling interactions between availers (110) and providers (310), comprising a user interface wherein a first user interface (120) is accessed by the plurality of availers (110) and a second user interface (320) is accessed by the plurality of providers (310), a platform (200), an assessment engine (210), a database module (220), and a segregation module (230). Further, the plurality of availers (110) may upload unedited manuscripts (130) showcasing the technical subject matter of a research onto the platform (200), which if approved by the assessment engine (210) may be stored in the database (220) and displayed to the plurality of providers (310). Subsequently, the plurality of providers (310) may be capable to showcase interest (250) in the manuscript (130) of interest.

### FIELD OF THE INVENTION

The present invention generally relates to the field of facilitating a selection of documents such as research article or manuscript for publication or funding, and more specifically a system and a method for enabling interaction between research authors and publishers or investors through a platform which minimizes the time research authors spend on submitting a research article or paper or manuscript to publishers/investors, and to flip the selection process from publishers/investors to the research authors.

### BACKGROUND OF THE INVENTION

Selection of a technological document is a cumbersome process which a provider has to adhere to, and a multitude of entries which do not meet basic criterion make the process more tiresome. Appropriate identification of a research article or manuscript has been the imperative of publishers/investors for many centuries, and research authors tend to submit personalized versions to each publisher/investor, which takes a lot of time at the author's end. Mostly, such research articles and manuscripts get declined since they fail to meet the criterion set by the publishers/investors, mainly on the contained technical matter in the research paper or manuscript. In the present invention, authors and researchers are being referred as availers; and journal editors, publishers, and funding institutes are referred as providers.

In the scenario of availers being authors and providers being publishers; publishing a research article or a paper/manuscript in a journal becomes an important activity within the academic community. Writing the research article or paper/manuscript which gets published in the journal is not an easy task as academic journals publish articles which are refined and well-written having a robust methodology. More specifically, most academic journals are interested to publish the research article or paper/manuscript which includes a technically sound and creative piece of research and which makes significant contributions to the knowledge base of the journal's specific discipline/guidelines/audience. Often, the research articles or papers/manuscripts are rejected by the academic journals before even going out to review because they are poorly written or they fail to meet the journal's publication requirements/guidelines. Such publication requirements may mean fundamental aspects of composing the research article or the paper/manuscript which can be published such as, but not limited to, submission guidelines.

Conventionally, authors decide on the most renowned journal in their field for their specific work for publication, and thereafter, submit the research article or paper/manuscript to the journal. In other words, authors read the widely-read and widely-cited articles in the specific journals and choose if their research article or paper/manuscript would fit better in that journal. After choosing the journal of their interest, the authors align their research article or paper/manuscript to meet the journal's publication requirements/guidelines in order to increase the chances of selection by the publishers and eventually publication in the journal of their interest for wider recognition.

Once the authors are satisfied that their research article or paper/manuscript meets the journal's publication requirements/guidelines, the research article or paper/manuscript is submitted through appropriate channels for publication. After submission of the research article or paper/manuscript, the same may be accepted with minor revisions or the research article or paper/manuscript may require substantial revisions before getting published or the research article or paper/manuscript may be rejected by the journal of their interest. In case of rejection, the author has to repeat the entire procedure again for a second choice of journal or some other journal altogether, for example, including a new writing style or developing a new anatomy of paper. Such a revision results in a substantial waste of time, effort and energy of the authors and researchers. Due to this, the researchers spend more time in revising their research article or paper/manuscript, rather than investing more time in research work.

Also, the conventional methods for publishing the research article or paper/manuscript lack a platform to exploit authors to choose a journal of interest from a number of journals. Further, the conventional methods lack a platform wherein the authors may simultaneously submit research article or paper/manuscript to multiple journals for consideration. This means that the conventional methods are time-consuming for authors who lose precious time waiting on a decision from a target journal. Furthermore, no platform currently exists that can manage direct communication between the two parties involved i.e. the journal publishers on one end and authors on the other. Additionally, pressure of publishing fast compromises the author's choice of target journal.

Similarly, in the scenario of availers being researchers and providers being funding organizations or investors, the researchers have a necessity of acquiring grants in order to facilitate their research. There exist multiple funding organizations and investors which provide funds to such researchers to assist them in completing their research. Although, such funding organizations and investors cannot facilitate funds to every single researcher who applies and thereby, all applications are assessed on a merit-bases of their contained technical subject matter which characterizes the research being performed by the researchers. Getting accepted for a grant is not an easy task as funding institutes accept researches which are commercially viable, having a deep-rooted research being conducted for the same. More specifically, most funding organizations are interested to fund researches that are creative, technically sound and makes significant contributions of knowledge while aligning with their ideologies as an organization.

Therefore, there exists a need to provide for a system and a method for enabling interaction between availers and providers, by way of selection of documents in the domain of publication of documents and allocation of grants. This would, in turn, address a variety of issues including, but not limited to, unnecessary wastage of time and energy due to the rejection of research article or paper/manuscript in the journal of interest and re-submission of the same research article or paper/manuscript in the other journals as well as the unnecessary wastage of time and effort in submitting a research to multiple funding organizations.

Further, there exists a need to provide for a system and a method for enabling interaction between availers and providers which circumvents these problem by inverting the selection process as a research article/paper/manuscript selection process and facilitates a number of journal editors/publishers or funding organizations/investors to express their interest in the author's research article or paper/manuscript and thus, allows the authors to choose a journal or organization of interest from a number of journals and organizations, at the same time. Also, there exists a need to provide for a system and a method for enabling interaction between availers and providers which shows relevant research articles or papers/manuscripts to the journal editors/publishers/funding organizations.

Therefore, in view of the above limitations of the conventional approaches, assemblies and methods, there exists a need to develop an improved approach, assembly and method which would in turn address a variety of issues including, but not limited to, publishers or editors of publications not getting the quality of technological content in submitted applications for publication that they could publish, authors having to edit their manuscript to suit the formatting and structural requirements of every single publication they apply to, funding organizations or investors not getting the quality of research that they wish to approve for grant, researchers not being able to appropriately bag and find the right funding organization, and even reduce the large volumes of applications publishers or funding organizations have to review regularly since they can showcase interest in the manuscripts that they prefer.

Further, there is a need of formulating a platform wherein such interactions can occur seamlessly in order to allow an author or researcher to submit their manuscripts which may be reviewed technically and assessed by publishers and investors alike, such that researchers do not have to format a manuscript to comply with every publication or organizational guideline for submission. Moreover, it is desired to develop a platform which allows publishers and investors to select manuscripts and showcase their interest, allowing the researcher to select one publisher or investor from all who have showcased interest in the manuscript.

Thus, the above-described deficiencies of conventional approaches, assemblies and methods thereof, are merely intended to provide an overview of some of the problems of conventional approaches and are not intended to be exhaustive. Other problems with conventional approaches, assemblies and methods and their corresponding benefits of the various non-limiting embodiments described herein may become further apparent upon review of the following description.

### SUMMARY OF THE INVENTION

The following presents a simplified summary of the invention to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

It is, therefore, an object of the present invention to provide a system and method for enabling interaction between multiple availers and providers through a platform. The platform in view of the foregoing disadvantages inherent in the prior-art, the general purpose of the present invention is to provide a platform that facilitates communication between availers, being authors or researchers and providers, being journals or publishers or funding organizations in order to make the process of selecting and publishing research papers as well as the process of selecting and approving researches for grant seamless, capable of including all advantages of the prior art while also overcoming the drawbacks inherent in the prior art offering some added advantages.

It is another object of the present invention to provide a platform which is accessible by a plurality of availers who can upload unedited manuscripts only displaying the scientific research contained in the same.

It is another object of the present invention to provide a platform which allows availers to upload unedited manuscripts only displaying the scientific research and not be required to edit their manuscripts in accordance to every provider they wish to apply to.

It is another object of the present invention to provide a platform which has an assessment engine which assesses the uploaded manuscripts according to a predetermined criterion and only the approved manuscripts actually get displayed on the platform.

It is another object of the present invention to provide a platform which filters all the approved manuscripts into different domains of technology and makes them visible only to the providers working in that particular domain of technology.

It is another object of the present invention to provide a platform which allows a provider to peruse through an unedited manuscript and assess if the same is interesting for them to publish in their journal/publication, or provide a grant for in accordance to their organizational requirements, or not.

It is another object of the present invention to provide a platform which allows a provider to showcase interest in a particular manuscript.

It is still another object of the present invention to provide a platform which lets the availer, being the researcher or author of a manuscript, to choose from the providers showcasing interest in that manuscript.

Accordingly, in an aspect, the present invention provides a platform which facilitates interaction between availers and providers such that the availers may upload unedited manuscripts onto the platform which may be reviewed by the providers. The providers may showcase interest in a manuscript that they wish to associate with after reviewing the same on the basis of the contained subject matter. All showcases of interest on a particular manuscript are shown to the availer who then may select one provider from all the providers showcasing interest in the manuscript.

Accordingly, in another aspect, the present invention provides a system and a method for enabling interaction between availers and providers through a platform.

Other aspects, advantages, and salient features of the invention will become apparent to those skilled in the art from the following detailed description, which, details the invention in different embodiments.

### BRIEF DESCRIPTION OF THE DRAWINGS

While the specification concludes with claims that particularly point out and distinctly claim the invention, it is believed that the advantages and features of the present invention will become better understood with reference to the following more detailed description of expressly disclosed exemplary embodiments taken in conjunction with the accompanying drawings. The drawings and detailed description which follow are intended to be merely illustrative of the expressly disclosed exemplary embodiments and are not intended to limit the scope of the present invention as set forth in the appended claims. In the drawings:

FIG. 1 illustrates a system for enabling interaction between availers and providers through a platform;

FIG. 2 illustrates a block diagram showing system interactions during submission of a manuscript;

FIG. 3 is a flowchart illustrating a method for enabling interaction between availers and providers through a platform;

FIG. 4 illustrates a block diagram showing segregation of manuscripts in different subject areas;

FIG. 5 illustrates a block diagram showing system interactions during perusal of manuscripts by providers;

FIG. 6 illustrates a block diagram showing system interactions during selection of a document; and

FIG. 7 illustrates a block diagram showcasing the method for enabling interaction between availers and providers through a platform.

### DETAILED DESCRIPTION OF THE INVENTION

### Call Out List

1000 System for enabling interaction between availers and providers
100 Availer's side
110 Availers
120 First user interface
130 Manuscript
200 Platform
210 Assessment Engine
220 Database
230 Segregation Module
240 Subject Matter Folders
250 Showcase of Interest
300 Provider's side
310 Providers
320 Second user interface

The exemplary embodiments described herein detail for illustrative purposes are subject to many variations in the structure and design. It should be emphasized, however, that the present invention is not limited to a particular prosthetic device as shown and described herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The use of terms “including,” “comprising,” or “having” and variations thereof herein are meant to encompass the items listed thereafter and equivalents thereof as well as additional items.

Further, the terms, “an” and “a” herein do not denote a limitation of quantity, but rather denote the presence of at least one of the referenced item.

Referring to the drawings, the invention will now be described in more detail. A system (1000) for enabling interaction between availers (110) and providers (310) through a platform (200), as shown in FIG. 1, comprising an assessment engine (210) and a database (220). The platform (200) may be accessed by a plurality of availers (110) through a first user interface (120) and by a plurality of providers (310) through a second user interface (320). The first user interface (120) and the second user interface (320) may be separate user interfaces or they may be the same user interface as well. The platform (200) may be accessed by way of the first user interface (120) and the second user interface (320) which may be a separate device or may be installed on an existing device like a computer, a tablet, a mobile phone, a tablet, a smart TV, or the like.

In accordance with an embodiment of the present invention, the availers (110) may be authors of research paper, researchers, innovators who research, academicians who wish to share their research including but not limited to professors, students, scholars, and the like; as well as scientists, analysists, doctors, professionals or any individual or individuals who has/have knowledge of a subject area.

In accordance with an embodiment of the present invention, the at least one availer from the plurality of availers (110) may be a single individual or a group of people who have worked together to formulate a research. In such a case, the ownership of the manuscript (130) lies with the group of researchers being qualified as the availer (110) who has uploaded the manuscript (130).

In accordance with an embodiment of the present invention, the providers (310) may be publishers or employees of publishing houses, editors of journals or other employees of a journal, funding organizations, investors, or the like. In some cases, the at least one provider from the plurality of providers (310) may be a single individual or a group of individuals who are taking the decision of selecting the manuscript (130).

In accordance with an exemplary embodiment of the present invention, the plurality of availers (110) may be authors and the plurality of providers (310) may be publishers, meaning that the present invention facilitates interaction between a plurality of authors (110) and a plurality of publishers (310) through the platform (200). The plurality of authors (110) utilize the first user interface (120) in order to access the platform and the plurality of publishers (310) utilize the second user interface (320) to access the platform.

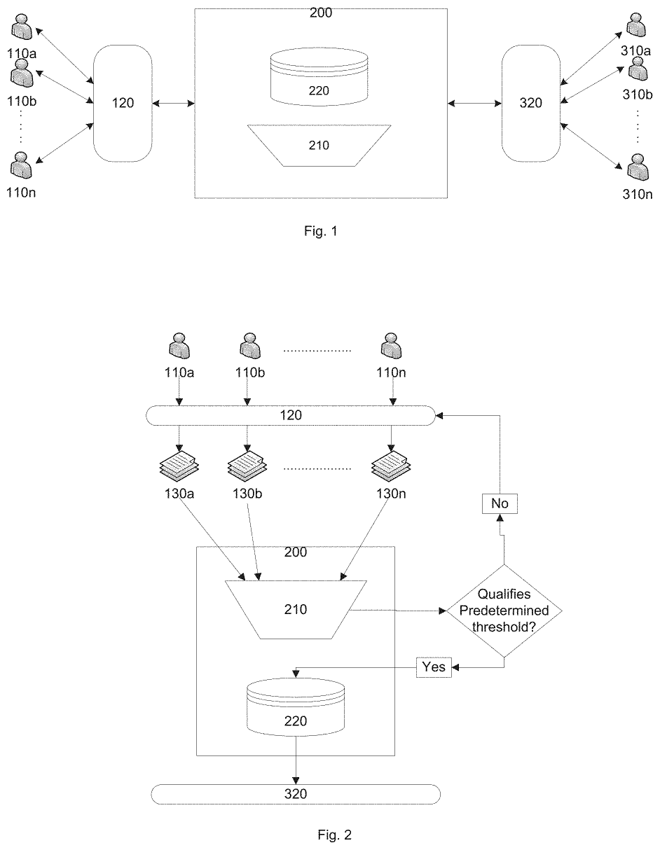

In accordance with an embodiment of the present invention and FIG. 2, the plurality of availers (110) may access the first user interface (120) to each upload at least one manuscript (130) to the platform (200). The at least one manuscript (130) are assessed by the assessment engine (210) on the basis of a predefined threshold. If a manuscript from the at least one manuscripts (130) uploaded by the plurality of availers (110) qualifies the predefined threshold, it is saved in the database (220) and thereafter visible to the second user interface (320), otherwise, if a manuscript from the at least one manuscripts (130) uploaded by the plurality of availers (110) does not qualify the predefined threshold, it is returned to the plurality of availers (110) through the first user interface (120) along with suggestions for improvement that includes a group of improvement points.

In accordance with an embodiment of the present invention, the availers (110) may be registered onto the platform (200) using the first user interface (120) based on a first set of predetermined requisites. The first set of predetermined requisites may include but not be limited to the name or names of the availer, contact information, and country of operation. The first set of predetermined requisites may also include further parameters including but not limited to the subject area of operation of the availer and the type of research.

In accordance with an embodiment of the present invention, the providers (310) may be registered onto the platform (200) using the second user interface (320) based on a second set of predetermined requisites. The second set of predetermined requisites may include but not be limited to the name or names of the provider, contact information, and country of operation. The second set of predetermined requisites may also include further parameters including but not limited to the subject area of operation of the provider, the name of the provider's organization and the provider's job title in the organization. The subject area of operation would include all necessary publication guidelines for research article's evaluation pertaining to that subject and specific to the provider.

In accordance with an exemplary embodiment of the present invention, the providers (310) may be journals or publishers. Herein, the second set of predetermined requisites may also include the name of the journal or publication or publisher.

In accordance with an embodiment of the present invention, the predefined threshold is determined by the technicalities of the subject matter of a manuscript (130), as well as the grammatical correctness of the at least one manuscript (130), specifically, it relates to an evaluation of the quality of language and grammar, ethical compliance, commercial declarations, reference quality, and table and figure references, among others. Further, the improvement points may relate to changes to any one or more of the evaluation points listed above, or other necessary improvements as understood by the assessment engine (210). Further, the group of improvement points is derived from a calibrated score of the evaluation points or the predefined threshold and a publication or usage guideline of one or more providers (310). More specifically, the assessment engine (210) extracts key concepts from manuscripts for performing semantic overlap with the publication guidelines of the one or more providers. The assessment engine (210) forecasts or suggest an improvement(s) for one or more providers (310) by understanding and using the group of improvement points.

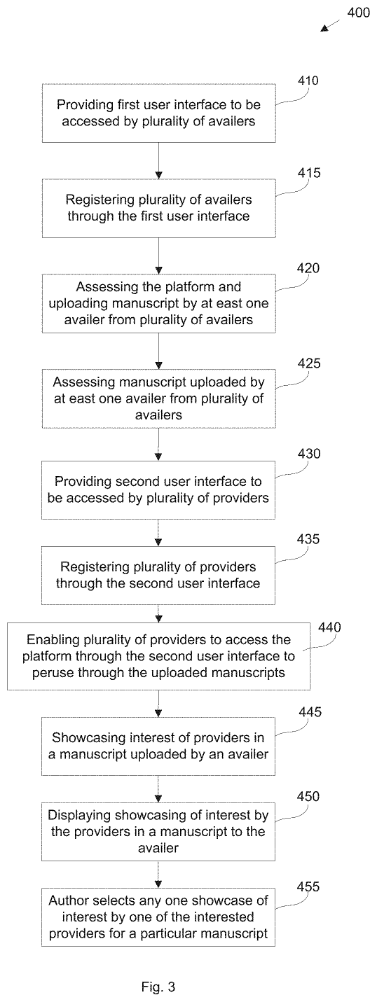

In accordance with an embodiment of the present invention, a method (400) for enabling interaction between availers (110) and providers (310) through a platform (200) is illustrated in FIG. 3. The method (400) for enabling interaction between availers (110) and providers (310) through a platform (200) includes a plurality of steps initiating at step 410, wherein the first user interface (120) is provided to be accessed by a plurality of availers (110) such that at step 415, the plurality of availers (110) can be registered through the first user interface (120). At step 420, the platform (200) may be assessed by the plurality of availers (110) from which at least one availer may upload a manuscript (130). The manuscript (130) uploaded by at least one availer from the plurality of availers (110) is assessed at step 425 by the assessment engine (210) wherein the manuscript (130) has to qualify a predetermined threshold to be accepted.

In accordance with an embodiment of the present invention, the method (400) for enabling interaction between availers (110) and providers (310) through a platform (200) further entails step 430, wherein a second user interface (320) is provided to the plurality of providers (310) such that the plurality of providers (310) may access the same, and at step 435, the plurality of providers (310) are registered onto the platform (200) through the second user interface. At step 440, the plurality of providers (310) are enabled to access the platform (200) through the second user interface (320) to peruse through the manuscripts (130) uploaded by the plurality of availers (110). A provider from the plurality of providers (310) may showcase interest (250) on a manuscript (130) uploaded by the plurality of availers (110) at step 445, subsequent to which, at step 450, the showcase of interest (250) by the plurality of providers (310) on a manuscript (130) are displayed to the plurality of availers (110). Finally, at step 455, at least one availer from the plurality of availers (110) selects any one showcase of interest (250) by one of the at least one provider from the plurality of providers (310) on a manuscript (130).

In accordance with an embodiment of the present invention and FIG. 4, the manuscripts (130) may be segregated into different subject areas on the basis of their contained information. FIG. 4 illustrates a block diagram showing segregation of manuscripts (130) in different subject areas (240), wherein, when an availer from the plurality of availers (110) uploads the manuscript (130) onto the platform (200) through the first user interface (120), the manuscript (130) is assessed by the assessment engine (210) as discussed above before being stored onto the database (220). If the manuscript (130) qualifies the predefined threshold, it is accepted by the platform (200), and sent to the segregation module (230) which segregates all manuscripts (130) on the basis of their subject areas. Herein, the manuscripts (130) are being segregated by the segregation module (230) and compartmentalized into folders of different subject areas (240).

In accordance with an embodiment of the present invention, the manuscripts (130) may be segregated by the segregation module (230) into different subject areas in a predefined manner; such that the domains of different folders having manuscripts of different subject areas (240) are specified within the segregation module (230). The folders having manuscripts of different subject areas (240) may include folders attributed to different domains of publishable literature, including but not limited to, the subject areas of computer science, electronics, telecommunication, life sciences, biotechnology, pharmacology, mechanical, automation, robotics, information technology, textiles, philosophy, medicine, civil engineering, and the like.

In accordance with an embodiment of the present invention, the folders having manuscripts of different subject areas (240) may include folders attributed to specific fields of within different domains of publishable literature, including but not limited to, the subject areas of machine learning, internet of things, driverless vehicles, generic products, production of bio-compounds, and the like.

In accordance with an embodiment of the present invention and FIG. 5, the manuscripts (130) may be perused by at least one provider from the plurality of providers (310) on the basis of the subject area of functioning of the publisher (310). For example, a provider working in the pharmacology domain would be shown manuscripts of pharmacology since the same would be more useful for the provider. FIG. 5 illustrates a block diagram showing system interactions during perusal of manuscripts by providers, wherein the at least one provider from the plurality of providers (310) accesses the platform (200) though the second user interface (320). On accessing the platform (200), the provider (310) may peruse through the manuscripts (130) categorized by the segregation module (230) in the folder having manuscripts of a subject area (240) in which the provider (310) functions.

In accordance with an embodiment of the present invention, if the provider (310) functions in multiple subject areas, the provider (310) may be able to peruse through the manuscripts (130) categorized in all the folders having manuscripts of subject areas (240) in which the provider (310) functions.

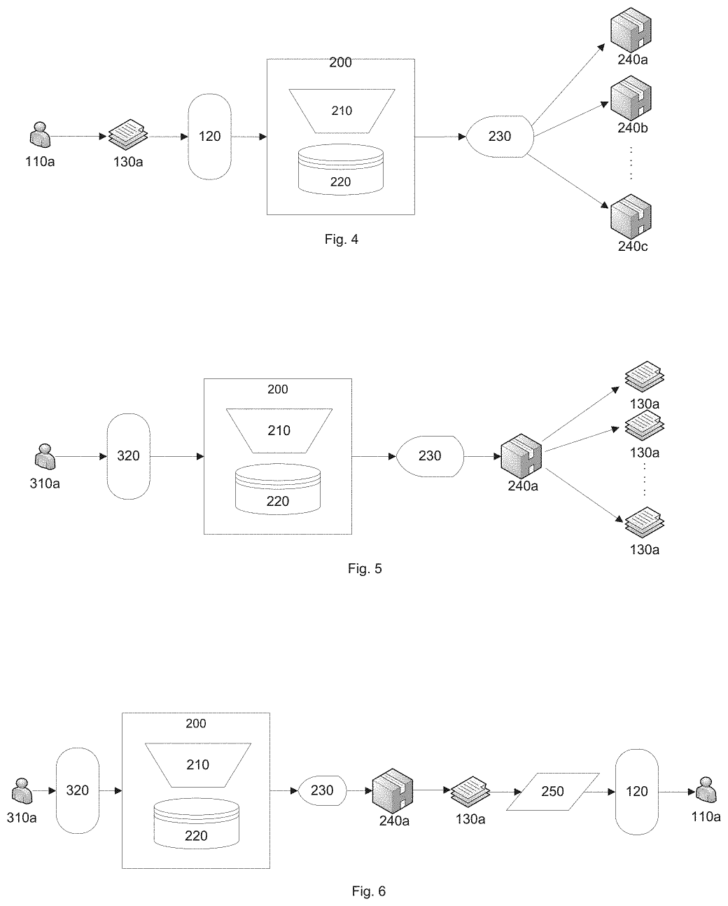

In accordance with an embodiment of the present invention and FIG. 6, the provider (310) may showcase interest (250) in the manuscript (130) uploaded by the availer (110), wherein the showcase of interest (250) is thereafter displayed to the availer (110). FIG. 6 illustrates a block diagram showing system interactions during selection of a document wherein the provider (310) accesses the platform (200) through the second user interface (320) and peruses through the manuscripts (130) categorized by the segregation module (230) into the folder having manuscripts of the subject area (240) that the provider (310) functions in. The provider (310) may thereafter showcase interest (250) in the manuscript (130) uploaded by the availer (110).

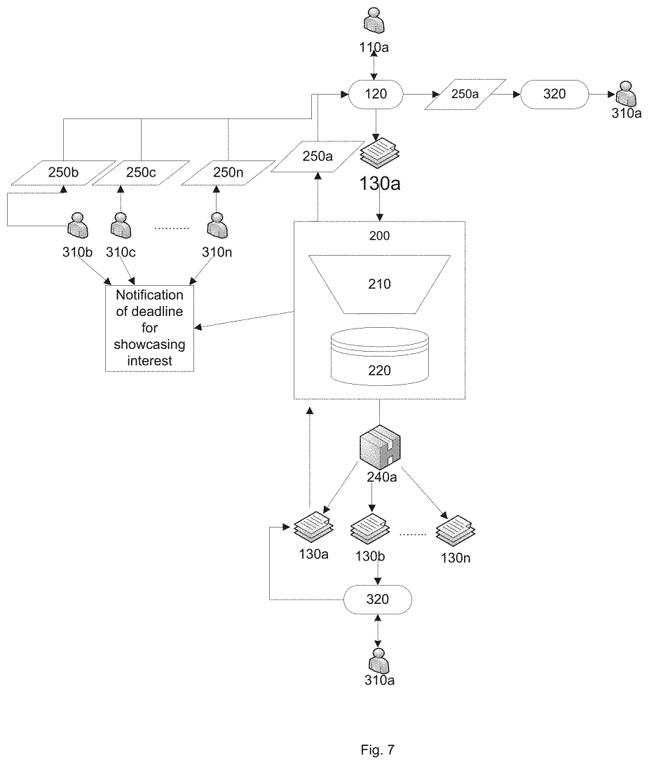

In accordance with an embodiment of the present invention, a block diagram showcasing the method for enabling interaction between availers (110) and providers (310) through a platform (200) is illustrated in FIG. 7. The availers (110) interact with the platform (200) through the first user interface (120) to upload manuscripts (130). When the manuscripts (130) are accepted by the assessment engine (210), they get segregated by the segregation module (230) and stored in different folders on the basis of their subject matter (240). On the other hand, the providers (310) interact with the platform (200) through the second user interface (320) wherein manuscripts (130) of the subject matter in which the publishers (310) function are shown to the providers (310). Thereafter, the providers (310) may select a manuscript (130a) through showcasing interest (250) in the same. At this instance, the platform (200) may send notifications to all other providers (310) functioning in the same subject area to showcase interest (250), if they wish to, in a stipulated timeline. The providers (310) may assess the manuscript (130a) and if they wish to associate with the same, they may showcase interest (250) as well. Further, all the showcases of interest (250) are displayed to the availer (110) for a manuscript (130a) through the first user interface (120), on the basis of which, the availer (110) may choose one showcase of interest (250) by one provider (310).

In accordance with an embodiment of the present invention, the availer from the plurality of availers (110) while selecting a showcase of interest (250) from the multiple showcases of interests (250) by the providers (310) on a manuscript (130), may select one showcase of interest (250) each by one type of providers (310). For example, the availer (110) may select one showcase of interest (250) by a provider (310) which is a research publication or journal, and a separate showcase of interest (250) by a provider (310) which is a funding organization or investor.

In accordance with an embodiment of the present invention, the system for enabling interaction between availers and providers may be used, but not limited to, in the field of IT industry, academic industry, publication industry, journals, funding organizations, investors, or the like. Further, the system for enabling interaction between availers and providers may be used by an individual or a group of individuals.

Apart from what has disclosed above, the present invention also includes some additional benefits and advantages. Few of the additional benefits are mentioned below:
The present invention provides the platform which prosthetic device which facilitates in enabling interaction between availers and providers. Further, the platform may be utilized by itself or be integrated with a pre-existing platform or website.
The platform functions in a manner to address the problem areas of the availers and providers in a manner that the availers do not have to unnecessarily submit the same research or manuscript to multiple organizations, and are able to choose from a number of interested providers; and the providers do not have to review multiple researches or manuscripts which are not technically sound.
The platform is made in such a way that the power of selecting a provider is given back to the availer when the availer chooses one showcase of interest from the multiple showcases of interest by the multiple providers.
The platform also provides a forum to the availers and providers wherein there is a transparency in decision-making activities, thereby, if a research or manuscript does not get approved by the assessment engine, the same is returned along with points for improvement.
The platform assists in reducing costs spent at the availer's end in applying to multiple providers separately by facilitating interaction through the platform itself.

The foregoing descriptions of exemplary embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

We claim:

1. A method for enabling interaction between availers and providers through a platform, the method comprising:
providing a first user interface to be accessed by a plurality of availers and a second user interface to be accessed by a plurality of providers;
registering the plurality of availers through the first user interface based on a first set of predetermined requisites;
accessing the platform through the first user interface by at least one availer from the plurality of availers;
uploading at least one manuscript each by the at least one availer from the plurality of availers through the first user interface;
assessing the manuscript uploaded by the at least one availer from the plurality of availers by an assessment engine on the basis of a predefined threshold wherein the assessment engine calculates the predefined threshold corresponding to a set of evaluation points for the manuscript;
forecasting an improvement by the assessment engine using a group of improvement points, wherein the group of improvement points is derived from a calibrated score of the predefined threshold and a publication guideline of at least one provider;
registering the plurality of providers through the second user interface based on a second set of predetermined requisites including the publication guideline;
enabling the plurality of providers to access the platform through the second user interface to peruse through the at least one manuscript uploaded by the at least one availer from the plurality of availers and assessed by the assessment engine;
showcasing interest by the at least one provider from the plurality of providers on the at least one manuscript uploaded by the at least one availer from the plurality of availers;
displaying the showcase of interest by the at least one provider from the plurality of providers to the at least one availer on the at least one manuscript uploaded by the at least one availer from the plurality of availers and assessed by the assessment engine;
wherein the platform allows the at least one availer to select any one showcase of interest by any one of the at least one provider from the plurality of providers on the at least one manuscript uploaded by the at least one availer from the plurality of availers, leading to a ‘handshake’ between the at least one availer and the at least one provider.

2. The method of claim 1, wherein the set of evaluation points for the manuscript comprising language, grammar, ethical compliance, commercial declarations, reference quality, and table and figure references are used for calculating the predefined threshold.

3. The method for enabling interaction between availers and providers through the platform as claimed in claim 1, wherein an availer may be a single individual or more than one individual who have worked on a singular manuscript or point of research for the same.

4. The method for enabling interaction between availers and providers through the platform as claimed in claim 3, wherein the availer may be a researcher, scientist, philosopher, analyst, doctor, professor, professional or any other individual or individuals who has/have knowledge of a subject area.

5. The method for enabling interaction between availers and providers through the platform as claimed in claim 1, wherein the provider may be a publisher, a journal, a research or science journal, a science readers digest, the editor of a journal or publication, an investor, a funding organization or employee thereof or any other individual or individuals who has/have knowledge of a subject area.

6. The method for enabling interaction between availers and providers through the platform as claimed in claim 1, wherein the at least one manuscript is categorized based on subject area it corresponds to.

7. The method for enabling interaction between availers and providers through the platform as claimed in claim 6, wherein the at least one manuscript can be viewed only by the plurality of providers working in at least one subject area as the at least one manuscript is categorized in.

8. The method for enabling interaction between availers and providers through the platform as claimed in claim 7, wherein if the at least one provider from a plurality of providers showcases interest on the at least one manuscript uploaded by the at least one availer from the plurality of availers, all other providers functioning in the at least one subject area that the at least one manuscript is categorized in are notified to showcase interest within a specific time frame for consideration.

9. A system for enabling interaction between availers and providers, the system comprising:
a user interface capable of enabling access to a plurality of availers and a plurality of providers wherein a first user interface is accessed by the plurality of availers and a second user interface is accessed by the plurality of providers;
a platform enabling the plurality of availers for uploading at least one manuscript, and the plurality of providers for perusing the at least one manuscript and showcasing interest in the at least one manuscript;
a database module capable of storing a list of the plurality of availers, the plurality of providers, the at least one manuscript uploaded by the plurality of availers, the showcase of interest by the plurality of providers, and the like; and
an assessment engine capable of assessing the at least one manuscript on upload by at least one availer from the plurality of availers on the basis of a predefined threshold wherein the assessment engine calculates the predefined threshold corresponding to a set of evaluation points for the manuscript, and forecasting an improvement using a group of improvement points, wherein the group of improvement points is derived from a calibrated score of the predefined threshold and a publication guideline of the at least one provider,
wherein the platform is capable of allowing the at least one availer from the plurality of availers to select any one showcase of interest by any one of the at least one provider from the plurality of providers on the at least one manuscript uploaded by the at least one availer, leading to a ‘handshake’ between the at least one availer and the at least one provider.

10. The system for enabling interaction between availers and providers through the platform as claimed in claim 9, wherein the set of evaluation points for the manuscript comprising language, grammar, ethical compliance, commercial declarations, reference quality, and table and figure references are used for calculating the predefined threshold.

11. The system for enabling interaction between availers and providers through the platform as claimed in claim 9, wherein an availer may be a single individual or more than one individual who have worked on a singular manuscript or point of research for the same.

12. The system for enabling interaction between availers and providers through the platform as claimed in claim 9, wherein the availer may be a researcher, scientist, philosopher, analyst, doctor, professor, professional or any other individual or individuals who has/have knowledge of a subject area.

13. The system for enabling interaction between availers and providers through the platform as claimed in claim 9, wherein the provider may be a publisher, a journal, a research or science journal, a science readers digest, the editor of a journal or publication, an investor, a funding organization or employee thereof or any other individual or individuals who has/have knowledge of a subject area.

14. The system for enabling interaction between availers and providers through the platform as claimed in claim 9, wherein the at least one manuscript is categorized based on subject area it corresponds to.

15. The system for enabling interaction between availers and providers through the platform as claimed in claim 13, wherein the at least one manuscript can be viewed only by the plurality of providers working in the at least one subject area as the at least one manuscript is categorized in.

16. The system for enabling interaction between availers and providers through the platform as claimed in claim 15, wherein if the at least one provider from a plurality of providers showcases interest on the at least one manuscript uploaded by the at least one availer from the plurality of availers, all other providers functioning in the at least one subject area that the at least one manuscript is categorized in are notified to showcase interest within a specific time frame for consideration.

17. A non-transitory computer-readable storage medium, having embodied thereon a program executable by a processor to perform a method for enabling interaction between availers and providers through a platform, the method comprising:
providing a first user interface to be accessed by a plurality of availers and a second user interface to be accessed by a plurality of providers;
registering the plurality of availers through the first user interface based on a first set of predetermined requisites;
accessing the platform through the first user interface by at least one availer from the plurality of availers uploading at least one manuscript each by the at least one availer from the plurality of availers through the first user interface;
assessing the manuscript uploaded by the at least one availer from the plurality of availers by an assessment engine on the basis of a predefined threshold wherein the assessment engine calculates the predefined threshold corresponding to a set of evaluation points for the manuscript;
forecasting an improvement by the assessment engine using a group of improvement points, wherein the group of improvement points is derived from a calibrated score of the predefined threshold and a publication guideline of at least one provider;
registering the plurality of providers through the second user interface based on a second set of predetermined requisites including the publication guideline;
enabling the plurality of providers to access the platform through the second user interface to peruse through the at least one manuscript uploaded by the at least one availer from the plurality of availers and assessed by the assessment engine;
showcasing interest by the at least one provider from the plurality of providers on the at least one manuscript uploaded by the at least one availer from the plurality of availers;
displaying the showcase of interest by the at least one provider from the plurality of providers to the at least one availer on the at least one manuscript uploaded by the at least one availer from the plurality of availers and assessed by the assessment engine;
wherein the platform allows the at least one availer from the plurality of availers to select any one showcase of interest by any one of the at least one provider from the plurality of providers on the at least one manuscript uploaded by the at least one availer from the plurality of availers, leading to a ‘handshake’ between the at least one availer and the at least one provider.
